(19) United States
(12) Patent Application Publication
(10) Pub. No.: US 2002/0180959 A1
(43) Pub. Date: Dec. 5, 2002

(54) Optical system for detecting surface defects and disk tester and disk testing method utilizing the same optical system

(76) Inventors: Hiroshi Nakajima, Tokyo (JP); Takayuki Ishiguro, Tokyo (JP)

Correspondence Address: MATTINGLY, STANGER & MALUR, P.C., Suite 370, 1800 Diagonal Road, Alexandria, VA, 22314, US

(21) Appl. No.: 10/152,838

(22) Filed: May 23, 2002

(30) Foreign Application Priority Data
May 30, 2001 (JP) 2001-162018

(51) Int. Cl. G01N 21/00

(52) U.S. Cl. 356/237.1

(57) ABSTRACT

A defect detecting optical system includes a light receiving optical system including an objective lens provided above the surface of the disk in parallel to the surface for receiving the scattered light and focusing an image of a test region of the disk on the light sensor through the objective lens and a plurality (n) of light illuminating systems provided around the objective lens equiangularly in a plane parallel to the disk with an angular interval of substantially 360°/n and emitting light beams to the test region with elevation angles in a range from 55° to 60° measured from the surface of the disk, where n is an integer equal to or larger than 3.

### BACKGROUND OF THE INVENTION

1. Field of the Invention

The present invention relates to an optical system for detecting surface defects and a disk tester and a disk testing method, which utilize the same optical system, and, particularly, the present invention relates to an optical system for detecting surface defects of a magnetic disk or an aluminum or glass substrate thereof, which has a simple construction and can detect surface defects with high precision without influence of directivity of scratches, chips, burs and other defect of a surface of the magnetic disk or the substrate, and to a disk tester and a disk testing method, which utilize the same optical system.

2. Prior Art Description

A hard magnetic disk used as a recording medium of a computer system has been tested on surface defect of a substrate disk as a basic material or a magnetic disk formed by painting the substrate with a magnetic film.

It has been known that the diameter of the recent magnetic disk is usually 95 mm or smaller and the recording density thereof is remarkably increased by the employment of GMR heads. In the disk of such kind, an aluminum or glass substrate having small thermal expansion coefficient has been used and the thickness thereof is as thin as in a range from 0.6 mm to 1.3 mm.

A typical example of a conventional surface defect tester for such magnetic disk is disclosed in U.S. Pat. No. 6,330,059 assigned to the assignee of this application. FIG. 5 corresponds to FIG. 1 of U.S. Pat. No. 6,330,059 and shows a construction of the surface defect tester disclosed therein.

As shown in FIG. 5, the conventional surface defect tester is constructed with a surface defect signal detecting and processing unit 4 and an optical system 5 for detecting surface defects. A disk 1 (magnetic disk or substrate thereof) is mounted on a spindle of a rotary mechanism (not shown) and rotated by a motor thereof. In the optical detection system 5, a laser beam LT from a laser light source 511 of a light illuminating system 51 is condensed by a condenser lens 521 to form a laser spot S on a surface of the disk 1.

That is, the light illuminating system 51 comprises the laser light source 511 comprising laser diodes (LD), a collimator lens 512, a first conical lens 513 pointed at a front end thereof and a second conical lens 514 pointed at a rear end thereof. The laser beams LT from the light source 511 pass through the collimator lens 512 to become parallel light having a circular cross section and is directed to the first conical lens 513 through the rear end thereof so that it is focused at a point F on the optical axis O. Light beams radiating from the focal point F are directed as annular light to the second conical lens 514, whereupon annular light beams are generated from its front face which is perpendicular to the optical axis O. In the embodiment under consideration, a distance L1 between the focal point F and the first conical lens 513 is set smaller than a distance L2 between the focal point F and the second conical lens 514. The angles of inclination of the cones of the two conical lenses are substantially the same.

In general, light radiating from a laser diode is expanded in longitudinal and lateral directions and the longitudinal and lateral expansions have different elliptic patterns. Therefore, in order to obtain a circular light pattern by expanding the elliptic pattern in a minor axis direction thereof, it is preferable to use a single-axis beam expander constructed with a convex cylindrical lens and a concave cylindrical lens. Therefore, although the collimator lens 512 is shown as a single lens, it should be noted that the collimator lens 512 could be constructed with these two cylindrical lenses.

The annular light emerging from the second conical lens 514 illuminates a circumferential reflective surface of a circular doughnut-shaped mirror 515 inserted into an optical path of light receiving optics 52 at an angle of about 45 degrees. The light is bent down by this mirror to illuminate the top surface of a hollow cylindrical objective lens 516 having a magnifying power comparable to that of a microscope. The annular light beams passing through this objective lens are focused at the test point S on the disk 1. A focal distance of the cylindrical objective lens 516 is several tens millimeters (e.g., 20 mm to 50 mm) and the cylindrical lens 516 is located at a position several tens millimeters above the surface of the disk 1. The elevation angle of illumination with the annular light beams from the objective lens 516 above the surface of the disk 1 is 70 degrees and, preferably, not more than 65 degrees.

The light receiving optical system 52 also includes a light receiving objective lens 521. The objective lens 521 is mounted in a hollow portion of the cylindrical objective lens 516 with a front end thereof being positioned inside a front end of the cylindrical objective lens 516 and has a magnifying power of 20× to 50× (focal distance of 20 mm to 50 mm), which corresponds to a magnifying power of the cylindrical objective lens 516, which is comparable with that of a microscope.

In this case, the disk 1 is helically scanned with illuminating light from the light illuminating system 51 and the reflected light from the test point S on the disk 1, which is scattered and received by the objective lens 521, is parallel light that passes through the center hole in the mirror 515 to be directed to an imaging lens 522 which in turn forms the image of the test point S on the light receiving surface of an APD sensor 523. A detection signal (output signal) from the APD 523 is input to a signal processing circuit 41 in a surface defect detecting and processing unit 4, where the defect F is detected. The size of the defect is classified or calculated from the amplitude of the output signal. The sensitivity of the signal processing circuit 41 is adjusted in accordance with the settings of various types of defects that have been predetermined by the circuit which then detects the size of the defect, optionally together with its depth or height.

In this defect tester, since the objective lens 521 of the light receiving system is arranged inside the cylindrical objective lens 516, it becomes difficult to receive light scattered by defect in or alien substance on the rear surface. As a result, S/N ratio of the detection signal obtained from the APD sensor 523 is improved and a defect detecting optical system capable of detecting defect with high precision without influence of the defect in the rear surface can be realized.

In such defect tester, however, it is necessary to produce the annular illuminating light with respect to the test point S of the disk. In order to produce such annular illuminating light, the light receiving objective lens must be arranged within the cylindrical objective lens. Further, since laser light passes through the mirror having the hole and the cylindrical objective lens, there is a problem that the illuminating efficiency of the light illuminating system is lowered.

On the other hand, scratches, chips, burs and other defect of the substrate may produce scattered lights having directivity in the direction perpendicular to the substrate surface. Therefore, in the defect detecting optical system, there may be a problem that the detection signal level is lowered and the defect detection becomes impossible depending upon the direction of scratches, chips, burs and other defect.

### SUMMARY OF THE INVENTION

An object of the present invention is to provide a defect detecting optical system having a simple structure and capable of detecting defect with high precision without influence of the directivity of scattered light from scratches, chips, burs and other defect in a substrate surface.

Another object of the present invention is to provide a defect tester using the same defect detecting optical system.

A further object of the present invention is to provide a defect testing method for detecting a surface defect of a disk.

In order to achieve the above objects, according to the present invention, a defect detecting optical system having a light receiving element for generating a signal for detecting a defect detecting signal by receiving scattered light from a surface of a disk scanned with light beam is featured by comprising a light receiving system including an objective lens for focusing an image of a test region of the disk by receiving the scattered light in a direction perpendicular to the surface of the disk through the objective lens and a plurality (n) of light illuminating systems provided around the light receiving system substantially uniformly with uniform angular interval of substantially 360°/n in a plane parallel to the disk and illuminating the test region with elevation angles measured from the disk surface being within a range from 55° to 60°, where n is an integer equal to or larger than 3.

A defect tester according to the present invention is featured by comprising the above mentioned defect detecting optical system.

A defect testing method according to the present invention is featured by illuminating the disk surface with light beams from the n light illuminating systems in such a way that the test region becomes elliptic, focusing an image of the test region on the light receiving element of the defect detecting optical system, scanning the disk surface with the light beams, obtaining detection signals corresponding to scattered lights reflected from the test region through an objective lens and detecting a defect on the basis of the detection signals.

As described, according to the present invention, 3 or more light illuminating systems are provided around the light receiving system substantially uniformly with uniform angular interval of substantially 360°/n in the plane parallel to the disk and illuminating the test region with light beams from the light illiminating systems with elevation angles thereof measured from the disk surface being within a range from 55d° to 60°. With such construction, it is possible to substantially equalize the scattered light from the defect in the test region of the disk surface, which is illuminated by light beams from the light illuminating systems, particularly, scattered light from scratches or chips in the test region, which have directivity in a direction perpendicular to the disk surface, over 360° range. Therefore, it becomes possible to detect defects such as scratches or chips in the disk surface, which has high directivity, as well as alien substances or other defects of the disk surface, which has low directivity.

Therefore, according to the present invention, it is possible to detect various defects with high precision and without influence of the directivity of scattered lights from defects such as scratches or chips of the disk surface. Further, since the optical system for producing the annular illuminating light, which is indispensable in the conventional defect detecting optical system, is unnecessary in the present invention, it is possible to realize a defect detecting optical system having a simple structure and to easily realize a defect tester by using the same optical system.

### BRIEF DESCRIPTION OF THE DRAWINGS

FIG. 1 is a perspective view of a defect detecting optical system according to an embodiment of the present invention;

FIG. 2(a) is a plan view of a disk, showing a relation between illuminating lights and reflected lights of the defect detecting optical system;

FIG. 2(b) is a side view of the disk;

FIG. 3(a) shows a rotation of laser light of a light illuminating system by rotating a laser light source in a test region of the disk;

FIG. 3(b) shows a rotation angle of the light illuminating system;

FIG. 3(c) shows the relation between rotation of laser light source and the test region of the disk;

FIG. 4(a) shows a relation between illuminating angles of scattered lights from a scratch or chip defect and the light illuminating system in the test region in a direction perpendicular to a disk surface;

FIG. 4(b) shows directivity characteristics of the scattered lights from the scratch or chip in the same direction when the illuminating angle of light from the light illuminating system (elevation angle from the disk surface) is 60°;

FIG. 4(c) shows directivity characteristics of the scattered lights from the scratch or chip in the same direction when the illuminating angle of light from the light illuminating system (elevation angle from the disk surface) is 55°;

FIG. 4(d) shows directivity characteristics of the scattered lights from the scratch or chip in the same direction when the illuminating angle of light from the light illuminating system (elevation angle from the disk surface) is 50°; and

FIG. 5 shows a conventional defect tester.

### DETAILED DESCRIPTION OF THE PREFERRED EMBODIMENTS

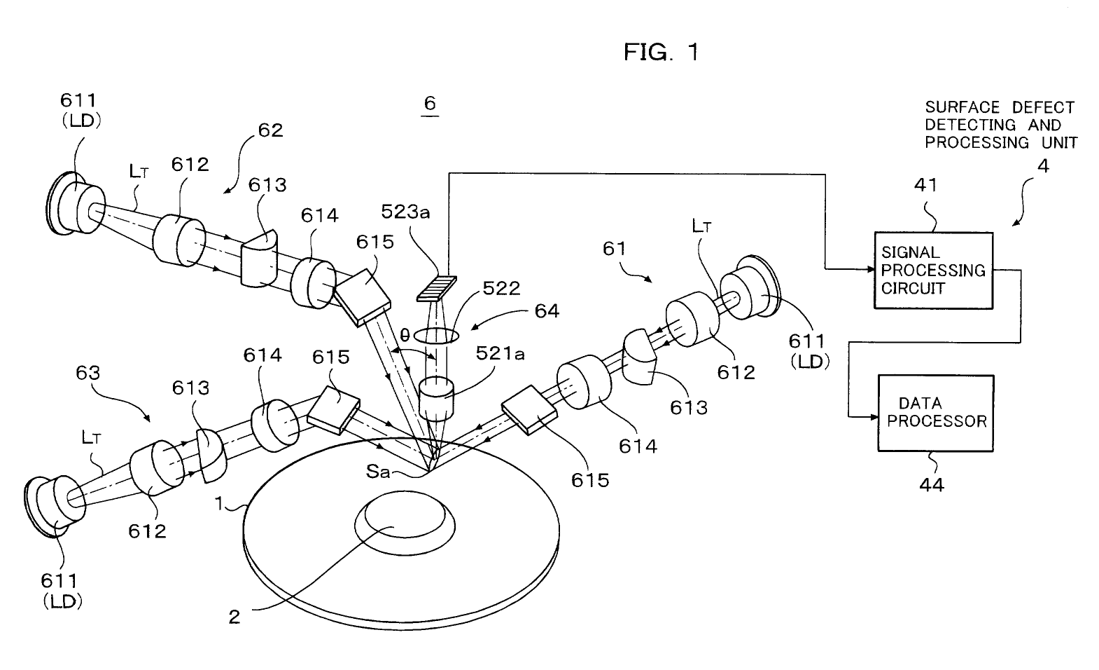

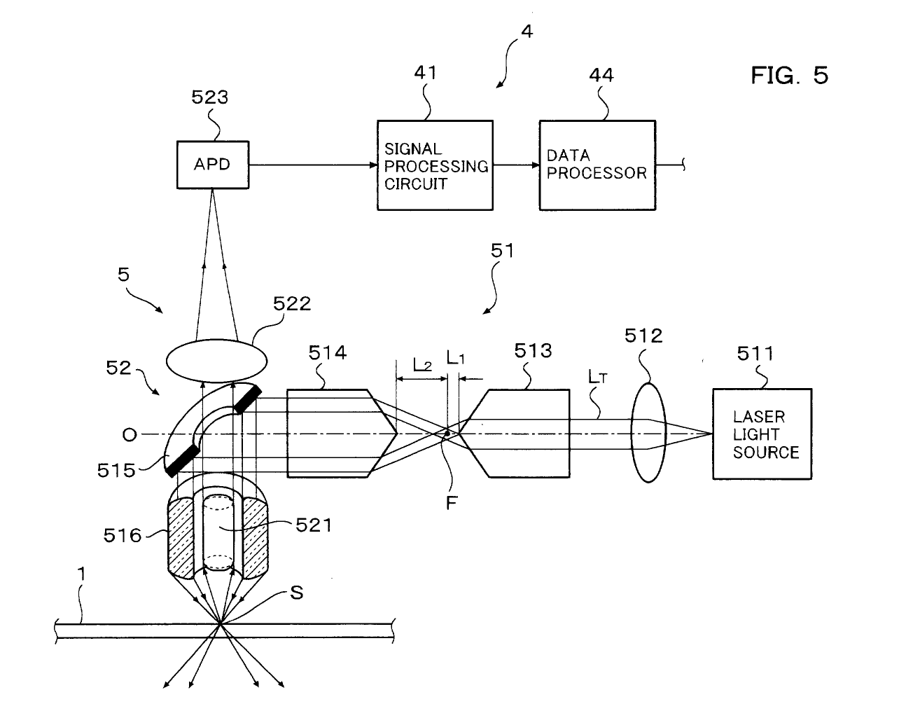

A defect tester shown In FIG. 1 includes a rotary mechanism 2 for rotating a disk 1 mounted on a spindle thereof, a defect detecting optical system generally depicted by reference numeral 6 including three light illuminating systems 61, 62 and 63 and a light receiving system 64 and a surface defect detecting and processing unit 4 including a signal processing circuit 41 and a data processor 44. It should be noted that the same constructive components of the defect tester as those shown in FIG. 5 are depicted by the same reference numerals, respectively, without detailed description thereof.

Each of the light illuminating systems 61, 62 and 63 is composed of a high luminance laser diode (LD) 611, a collimator lens 612, a cylindrical lens 613, a focusing lens 614 and a mirror 615.

In the light illuminating systems, laser beams LT from the laser light sources 611, which are rotated about their centers, are collimated to parallel beams by the collimator lenses 612 and focused on the mirrors 615 through the cylindrical lenses 613 and the focusing lenses 614, respectively. Light beams reflected by the mirrors 615 are focused to a test region Sa of a surface of the disk 1. Incidentally, when an axis of the test region Sa, which is formed by light beam from one of the light illuminating systems 61, 62 and 63, is made coincident with a radial (R) direction or a rotating direction of the disk, the light source of the one light illuminating system is not required to be rotated about its axis.

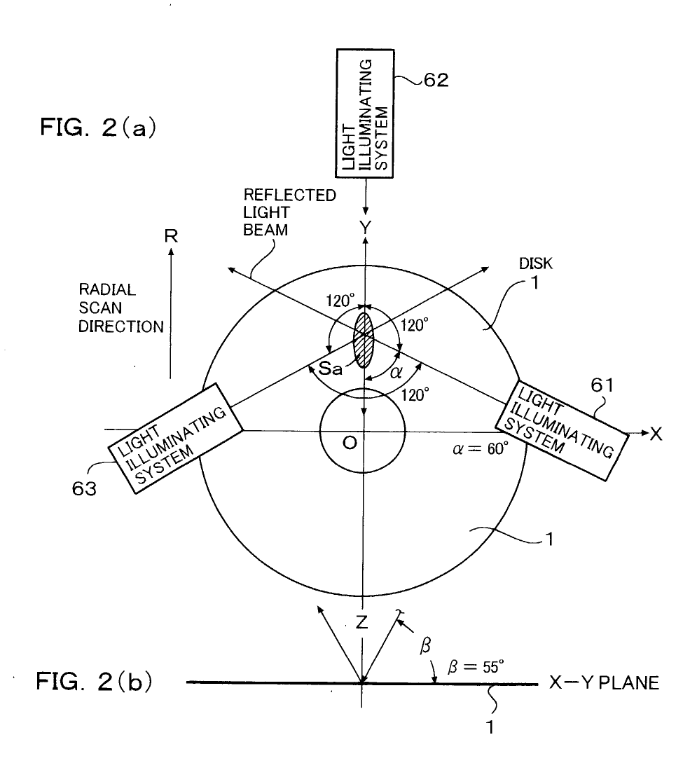

In the light illuminating systems 61, 62 and 63, an offset is given to a beam waist in the R direction to shift the focal point ahead. On the other hand, in the disk rotating direction, light beam passed through the cylindrical lens 613 is focused on the surface of the disk 1 through the focusing lens 614. As a result, a beam spot in the form of an ellipsoid having a major axis in the radial direction is formed as the test region Sa as shown in FIG. 2(a).

Illuminating angle of each of the light illuminating systems 61, 62 and 63 with respect to the disk 1 is set by setting the mirror 615 in such a way that an elevation angle β measured from the surface of the disk 1 becomes substantially 55° as shown in FIG. 2(b), that is, an angle θ from a normal line in FIG. 1 is 35°. The light illuminating systems 61, 62 and 63 are arranged substantially equiangularly in a plane parallel to the surface of the disk 1 with angular gap of 120° (360°/n, where n is 3) between adjacent light illuminating systems and form the same elliptic test regions Sa on the disk as shown in FIG. 2(a).

In more detail, in rectangular X-Y coordinates having an original point O coincident with a center axis of the disk 1 and Y axis coincident with the R direction of the disk 1, the illuminating angles of the light beams from the light illuminating systems 61, 62 and 63 with respect to the surface of the disk 1 are 60°, 180° and −60°, respectively, as shown in FIG. 2(a) and tilt angles β of the light beams from the light illuminating systems 61, 62 and 63 with respect to the X-Y plane are 55°, respectively, as shown in FIG. 2(b). The light receiving system 64 includes an objective lens 521a, which corresponds to the objective lens 521 shown in FIG. 5, has magnifying power comparable with that of a microscope and provided above the test region Sa, a focusing lens 522 and an APD sensor 523a. Reflected light from the test region Sa passes through the objective lens 521a and the focusing lens 522 to focus an image of the test region Sa on a light receiving surface of the APD sensor 523a. In this embodiment, a focal distance of the objective lens 521a is in a range from 20 mm to 50 mm.

The APD sensor 523a includes a plurality of light receiving elements arranged in the R direction, that is, along the major axis of the elliptic test region, of the disk 1. In this embodiment, 23 light receiving elements each 0.5 mm wide are arranged. For example, width of the test region Sa in the major axis direction, which is about 100 μm to about 150 μm, corresponds to the length of the 23 light receiving elements of the APD sensor, which is about 11.5 mm. That is, the width of each of the light receiving elements in the arranging direction thereof corresponds to in the order of 5 μm on the surface of the disk 1.

Illuminating lights from the light illuminating systems 61, 62 and 63 separated mutually by 120° in the plane parallel to the surface of the disk 1 are regulated by rotating the laser light sources 611 such that the test regions Sa defined thereby on the surface of the disk 1 become coincident.

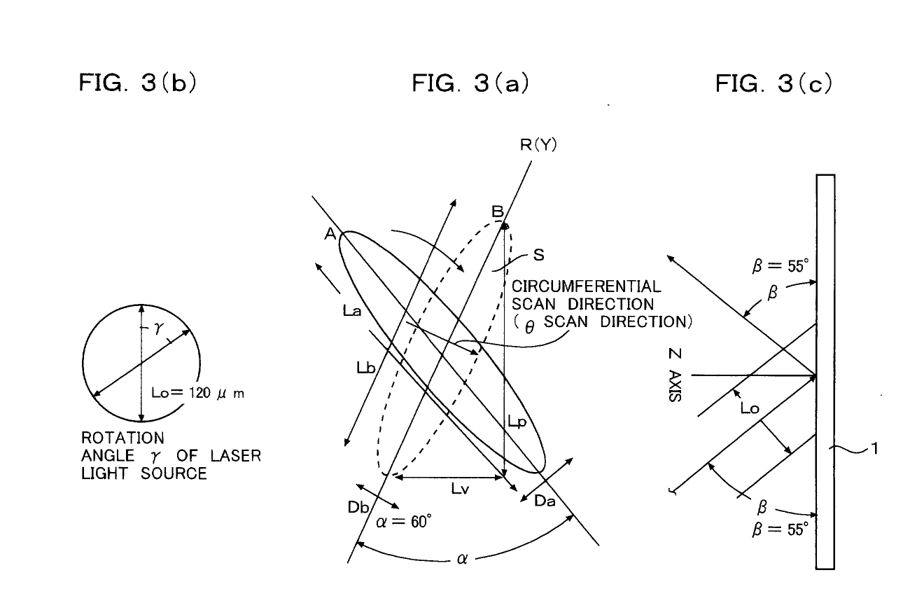

Describing the rotation of laser light source with reference to FIGS. 3(a) to 3(c), laser light from, for example, the light illuminating system 61, is rotated by an angle γ by rotating the laser light source 611 thereof, so that an elliptic image A becomes an elliptic image B as shown in FIG. 3(a). The rotation angle γ of the laser light from the light illuminating system 61 shown in FIG. 3(b) is obtained from the relations shown in FIGS. 3(a) and 3(c).

That is, when the surface of the disk 1 is illuminated by a laser beam in a direction defined by the horizontal angle a and the tilt angle β, an image formed thereon becomes the ellipsoid A having major axis length La and minor axis length Da as shown in FIG. 3(a). Assuming that La is, for example, 240 μm, Da is, for example, 15 μm and Lo is length of the major axis of the cross section of the laser beam in the vicinity of the disk as shown in FIG. 3(c), the laser light from the light illuminating system 61 is rotated by an angle γ to rotate the ellipsoid A shown by the solid line to thereby obtain the test region Sa in the form of the ellipsoid B having major axis length Lb and minor axis length Db, which is set on the surface of the disk 1 as shown in FIG. 3(a). In this case, the laser beam waist Do is 15 μm wide and the length of the major axis of the elliptic cross section of the laser beam is 120 μm long.

In FIG. 3(a), the length La of the major axis of the ellipse A, length Lv of a horizontal line segment extending from a lower end of the major axis of the ellipse B and a length Lp of a vertical line segment extending down from an upper end of the major axis of the ellipse B to the horizontal line segment and a length Lb in the radial (R) direction, which corresponds to a tilt side length of a right triangle defined by the horizontal line segment Lv and the vertical line segment Lp and is coincident with the Y axis of the X-Y rectangular coordinates, are represented as follows:

La=Do×1/sin α=240 μm

Lv=Lo×sin γ

Lp=Lo×cos γ×1/sin β=2Lo×cos γ

respectively, and

Lv/Lp=tan α

As a result, it is possible to calculate the length Lb of the major axis of the test region Sa of the ellipse B and the width Db thereof. Detailed description of the calculating method thereof is omitted since it is disclosed in Japanese Patent Application No. 2000-244370 assigned to the assignee of the present application.

For the light illuminating system 63, a cross section of the laser beam is made coincident with the test region Sa by rotating the laser beam similarly. However, since the laser light from the light illuminating system 62 has a cross section having major axis at an angle 180° with respect to the Y axis of the rectangular coordinates system, it, is unnecessary to rotate the light source thereof.

In the defect test, the laser lights emitted from the three light illuminating systems 61, 62 and 63 of the light illuminating system 6 illuminate the disk 1 mounted on the spindle 2 (FIG. 1) and the disk 1 is helically scanned thereby. Scattered lights reflected by the test region Sa of the disk 1 is received by the objective lens 521a, guided to the focusing lens 522 and converted into the detection signal by the APD sensor 523. The detection signal is inputted to the signal processing circuit 41 of the surface defect detection processor 4 and the defect F is detected thereby.

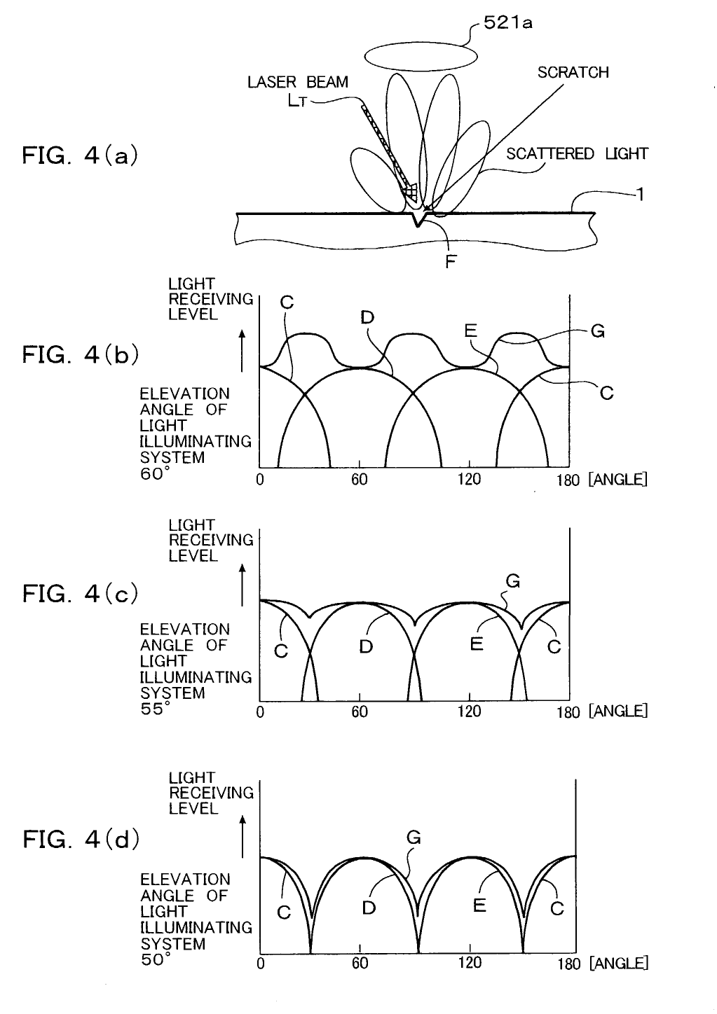

FIGS. 4(a) to 4(d) illustrate a relation between the directivity of scattered lights from a scratch or chip in the test region Sa and the light illuminating system.

In FIG. 4(a), which illustrates a relation between the illuminating angle of the light illuminating system and the scattered lights from the scratch or chip, the scattered lights from the defect F such as scratch or chip illuminated by the illuminating lights LT from the light illuminating systems 61, 62 and 63 of the light illuminating system 6 have directivity in directions vertical to the surface of the disk 1. The objective lens 521a arranged in parallel to the surface of the disk 1 receives the scattered lights in the directions vertical to the surface of the disk 1.

In FIG. 4(b), which illustrates a relation between the light receiving level of the objective lens 521a and the scattering characteristics of the illuminating lights of the light illuminating systems, capital letter C indicates the directivity characteristics of the scattered lights from the defect in the vertical direction when the illuminating angle of the light illuminating system 61, that is, the elevation angle with respect to the surface of the disk 1, is 60°. It is clear that substantially the same characteristics can be obtained in the illuminating angle range from 180 degrees to 360 degrees due to forward scattering and back scattering. Capital letter D indicates the directivity characteristics of the scattered lights from the defect in the vertical direction for the light illuminating system 62 and capital letter E indicates the directivity characteristics of the scattered lights from the defect in the vertical direction for the light illuminating system 63.

Capital letter G shows a total level of the scattered lights obtained for the respective light illuminating systems, which are received by the objective lens 521a of the embodiment shown in FIG. 1.

FIG. 4(c) is similar to FIG. 4(b) and illustrates the directivity characteristics of the scattered lights when the elevation angle of each of the light illuminating optical systems is 55 degrees and FIG. 4(d) shows the directivity characteristics when the elevation angle is 50 degrees. In FIG. 4(d), the total light receiving level G is not smoothed.

As is clear from the directivity characteristics shown FIGS. 4(b) to 4(d), when the light illuminating optical systems 61, 62 and 63 are arranged equiangularly in the plane parallel to the disk 1 with elevation angles thereof being in the range from 55 degrees to 60 degrees, the characteristics G is smoothed throughout the disk, so that the detection level can be substantially averaged throughout 360 degrees regardless of the direction of the defect.

Although the total characteristics G when the elevation angle is 60 degrees is some what irregular as shown in FIG. 4(a), such irregularity can be improved by increasing the number of the equiangularly arranged light illuminating systems.

In the described embodiment, the defect tester includes three light illuminating optical systems. However, it is of course possible that the defect tester includes four or more equiangularly arranged light illuminating systems as mentioned above. Further, in the described defect tester, laser beam is used. In such case, it is preferable that the laser beam is S polarized laser beam. However, the present invention is not limited to the use of laser beam. It is of course possible to use white light as the illuminating light.

Further, although the disk is helically scanned in the described embodiment, the disk scanning is not limited thereto. For example, the disk can be X-Y scanned.

What is claimed is:

1. A defect detecting optical system including a light sensor responsive to scattered light from a surface of a disk scanned by a light beam for generating a signal to be used to detect defects of said surface of said disk, comprising:
a light receiving system including an objective lens provided above said surface of said disk in parallel to said surface for receiving said scattered light and focusing an image of a test region of said disk on said light sensor through said objective lens; and
a plurality (n) of light illuminating systems provided around said objective lens of said light receiving system equiangularly in a plane parallel to said disk with an angular interval of substantially 360°/n and emitting light beams to said test region with light beams from the light illiminating systems with elevation angles in a range from 55° to 60° measured from said surface of said disk, where n is an integer equal to or larger than 3.

2. A defect detecting optical system as claimed in claim 1, wherein said light beams are laser beams and said image of said test region is elliptic having a major axis or a minor axis coincident with a main scan direction or a sub scan direction and wherein said light sensor includes a plurality of light receiving elements arranged in a direction coincident with said main or sub scan direction of said image of said test region, said image being received by the plurality of said light receiving elements.

3. A defect detecting optical system as claimed in claim 2, wherein a light source of at least one of said light illuminating systems, which is arranged in a direction inconsistent with said main or sub scan direction, is rotated.

4. A defect detecting optical system as claimed in claim 3, wherein a focal distance of said objective lens is in a range from 20 mm to 50 mm.

5. A defect tester including a light sensor responsive to scattered light from a surface of a disk scanned by light beams for generating a signal to be used to detect defects of said surface of said disk, comprising:
a light receiving system including an objective lens provided above said surface of said disk in parallel to said surface for receiving said scattered light and focusing an image of a test region of said disk on said light sensor through said objective lens; and
a plurality (n) of light illuminating systems provided around said objective lens of said light receiving system equiangularly in a plane parallel to said disk with an angular interval of substantially 360°/n and emitting light beams to said test region with light beams from the light illiminating systems with elevation angles in a range from 55° to 60° measured from said surface of said disk, where n is an integer equal to or larger than 3.

6. A defect tester as claimed in claim 5, wherein said light beams are laser beams and said image of said test region is elliptic having a major axis or a minor axis coincident with a main scan direction or a sub scan direction and wherein said light sensor includes a plurality of light receiving elements arranged in a direction coincident with said main or sub scan direction of said image of said test region, said image being received by the plurality of said light receiving elements.

7. A defect tester as claimed in claim 6, wherein a light source of at least one of said light illuminating systems, which is arranged in a direction inconsistent with said main or sub scan direction, is rotated.

8. A defect tester as claimed in claim 7, wherein a focal distance of said objective lens is in a range from 20 mm to 50 mm and said disk is helically scanned.

9. A defect testing method for generating a signal to be used to detect defects of a surface of a disk by a light sensor responsive to scattered light from the surface of the disk scanned by light beams, comprising the steps of:
arranging an objective lens above the surface of the disk;
arranging a plurality (n) of light illuminating systems provided around said objective lens equiangularly in a plane parallel to said disk with an angular interval of substantially 360°/n and emitting light beams to said test region with light beams from the light illiminating systems with elevation angles in a range from 55° to 60° measured from said surface of said disk, where n is an integer equal to or larger than 3;
forming an elliptic test region on the surface of the disk by illuminating the surface of the disk with light beams from said n light illuminating systems;
focusing an image of said test region on said light sensor through said objective lens; and
detecting defects by obtaining a detection signal corresponding to scattered lights from said test region by scanning said disk with the light beams.

10. A defect testing method as claimed in claim 9, wherein said light beams are laser light beams, said test region is elliptic having a major axis or a minor axis coincident with a main scan direction or a sub scan direction and wherein said light sensor includes a plurality of light receiving elements arranged in a direction coincident with said main or sub scan direction of said image of said test region, said image being received by the plurality of said light receiving elements.
